(19) United States
(12) Patent Application Publication
(10) Pub. No.: US 2023/0391241 A1
(43) Pub. Date: Dec. 7, 2023

(54) Seat Headrest Assembly

(71) Applicant: Sergio Millan, Santa Fe Springs, CA (US)

(72) Inventor: Sergio Millan, Santa Fe Springs, CA (US)

(21) Appl. No.: 18/200,928

(22) Filed: May 23, 2023

Related U.S. Application Data
(60) Provisional application No. 63/348,242, filed on Jun. 2, 2022.

(51) Int. Cl. B60N 2/885; B60N 2/809; B60N 2/838

(52) U.S. Cl. CPC B60N 2/885; B60N 2/838; B60N 2/809

(57) ABSTRACT

A fully adjustable headrest with foldable head support wings for use in connection with furniture and with passenger vehicles such as aircraft, trains, and buses.

### CROSS-REFERENCE TO RELATED APPLICATIONS

This is a. Non-Provisional application claiming the benefit of co-pending, Provisional Application No. 63/348,242 filed Jun. 2, 2022.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention relates generally to headrests for seats. More particularly, the invention concerns a fully adjustable headrest with foldable head support wings for use in connection with furniture and with passenger vehicles such as aircraft, trains, and buses.

### Discussion of the Prior Art

Various types of headrests for use in passenger vehicles have been suggested in the past. As the general rule, these headrests are designed primarily to satisfy comfort aspects and have limited adjustability features. Typically, the prior art vehicle headrests comprise only a vertically adjustable head support member designed to provide protection against injury in the event of an accident. However, some vehicle headrests have also been provided with lateral headrest elements.

In addition to passenger vehicle headrests, a number of headrests have been designed for use in emergency vehicles. These types of headrests are of a more complicated design and some include greater adjustability features.

Even more complex headrests have been designed for use in military aircraft and, more particularly in military aircraft for use in conjunction with ejection seats, Typical of this class of headrest design are those disclosed in U.S. Pat. Nos. 4,883,243 and 4,899,961.

In addition to the development of headrests for use in military aircraft, significant advances have been made in recent years in the design of headrests for use in commercial aircraft. Many of these headrests are designed for personal comfort and include pivotally movable back and lateral supports. In these latter types of headrests; the head support members are typically slidably mounted on spaced apart rods that extend upwardly from the back of the seat and rely on friction to maintain the headrest in an elevated position.

As will become clear from the discussion that follows, the headrest of the present invention represents a substantial improvement over the prior art headrests and in addition to providing greater comfort and safety, also provide novel adjustability features. More particularly, the headrest of the present invention incorporates foldable wings that are slidably adjustable and readably removable for storage.

### SUMMARY OF THE INVENTION

By way of brief summary, the present invention concerns a headrest for use in passenger vehicles that includes a passenger head support assembly that can readably be connected to a passenger seat and one that includes a central head support, first and second connecter members slidably connected to the central head support and first and second adjustable head support wings pivotally connected to the central head support.

With the foregoing in mind, it is an object of the invention to provide a vertically adjustable headrest that provides both support and comfort to the user and one that is suitable for use in connection with various types of passenger vehicles, including commercial aircraft.

Another object of the invention is to provide a headrest of the aforementioned character that uniquely includes first and second head support wings that are slidably adjustable relative to a central head support.

Another object of the invention is to provide a seat headrest as described in the preceding paragraph in which the first and second head support wings are each connected to an elongate connector member that, in turn, is slidably connected to the central head support so as to permit mover rent of the first and second head support wings relative to the central head support between a first position and a second position.

Another object of the invention is to provide a seat headrest as described in the preceding paragraph in which the first and second head support wings are each pivotally connected to an elongate connector member so as to permit movement of the head support wings between a stowed position and a 90 degree outwardly extended position.

Another object of the invention is to provide a seat headrest as described in the preceding paragraphs that includes readably removable head support wings.

Another object of the invention is to provide a seat headrest as described in the preceding paragraphs in which the central head portion panel is wider than no al and in which the head support wings of the headrest are adjustable relative to the central head portion panel so as to enable easy passenger adjustment of the width of the passenger head space.

Still another Object of the invention is to provide a seat headrest that is of a simple design, is easy to manufacture, and is durable in use.

### BRIEF DESCRIPTION OF THE DRAWINGS

FIG. 1 is a generally perspective, illustrative view of the headrest as it functions to provide comfort and support to the passenger when the wing connecter members are slidably closed and the foldable wings are deployed.

FIG. 1B is a side elevational, illustrative view of the headrest shown in FIG. 1 as it functions to provide comfort and support to the passenger when the wing connecter members are slidably closed and the foldable wings are deployed.

FIG. 2 is a generally perspective, rear view of the seat headrest showing the central portion thereof connected to the mounting assembly which, in turn, is connectable to the vehicle seat.

FIG. 3 is a side view of the seat headrest showing the central portion thereof connected to the mounting assembly which is, in turn, connectable to the vehicle seat.

FIG. 4 is a generally perspective front view of the seat headrest showing the connector members thereof in the fully retracted position and foldable wings in a deployed position.

FIG. 5 is a generally perspective, front view of the seat headrest similar to FIG. 4 showing the connector members in an extended position and the foldable wings in a deployed position.

FIG. 6 is a generally perspective, exploded front view of the seat headrest similar to FIG. 4 showing one of the connector members in ail extended position and the other disconnected from the central portion of the headrest,

FIG. 7 is a generally perspective, exploded rear view of the seat headrest similar to FIG. 2 showing one of the connector members in an extended, locked position and the other disconnected from the central portion of the headrest.

FIG. 8 is a generally perspective, exploded rear view of the seat headrest similar to FIG. 7 but showing both of the connector members along with the foldable wings disconnected from the central portion of the headrest.

### DESCRIPTION OF THE INVENTION

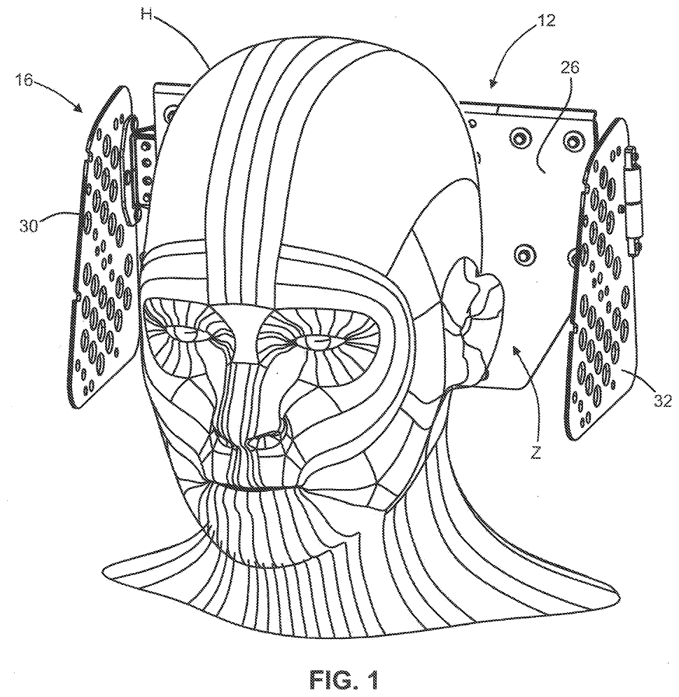

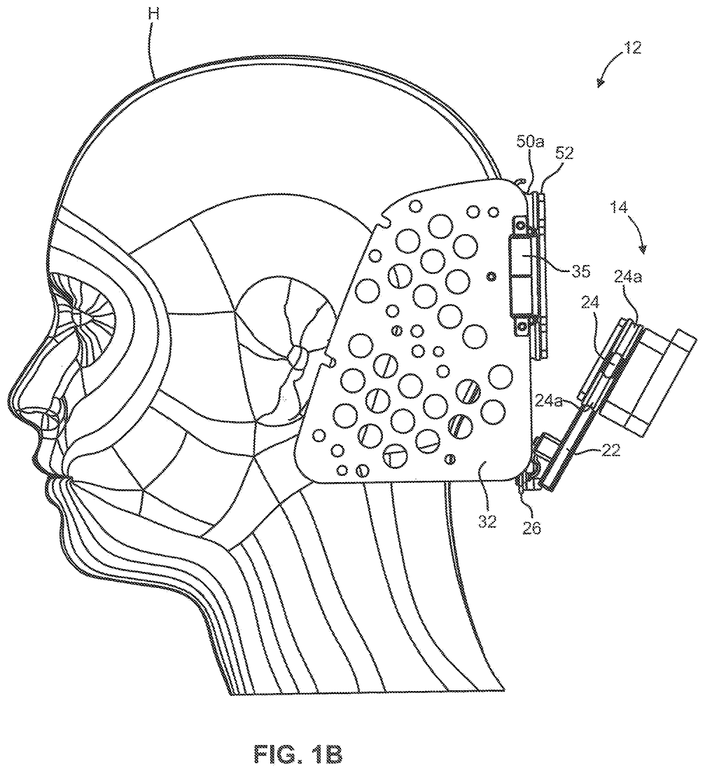

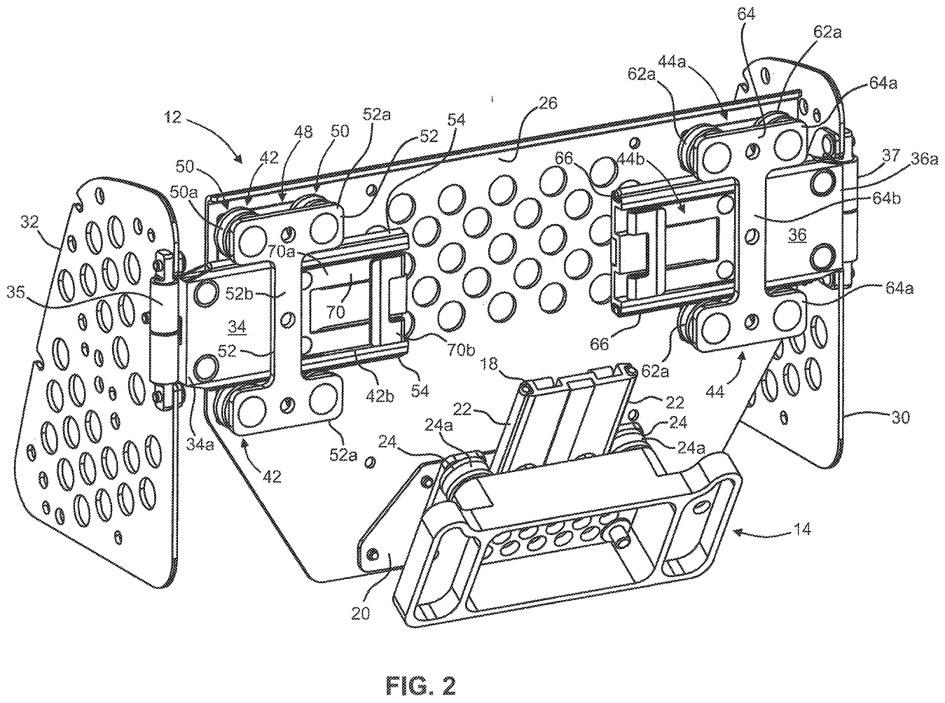

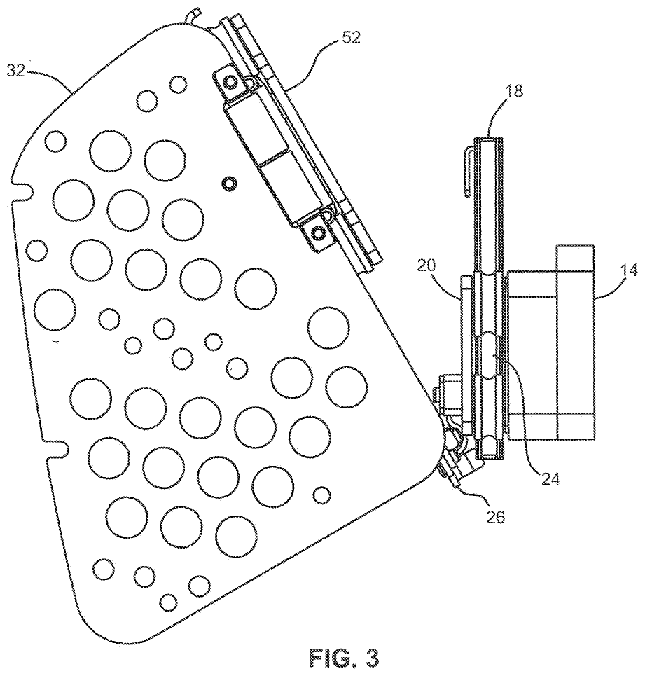

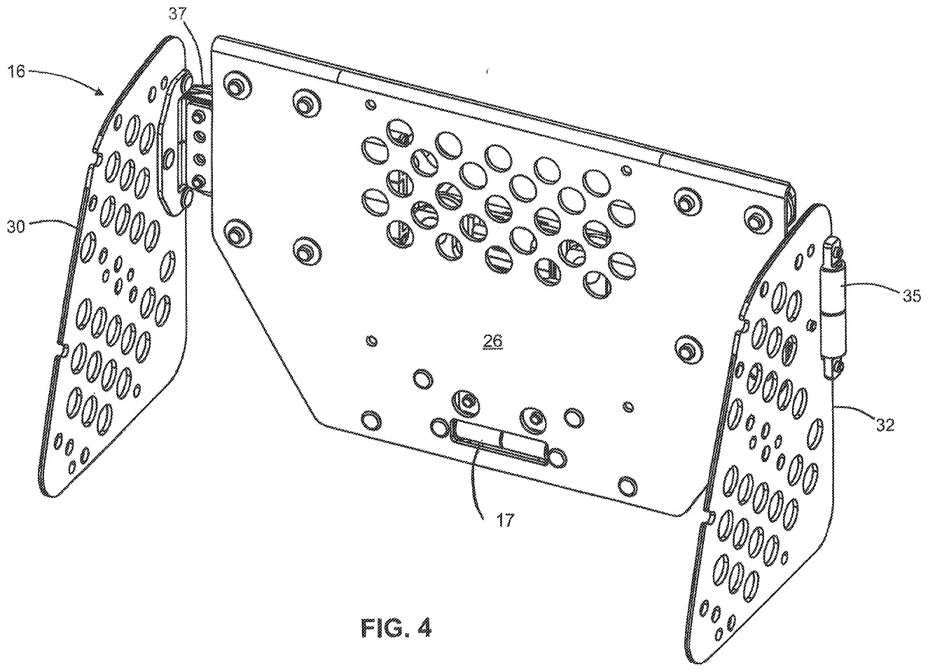

Referring to the drawings and particularly to FIGS. 1, 1B and 2, one form of the seat headrest assembly of the invention is there illustrated and generally designated by numeral 12. Assembly 12 which is suitable for use in connection with various types of passenger vehicles, here comprises mounting assembly 14 (FIG. 1B) and a passenger head support assembly 16 (FIG. 1) that are interconnected by means of a conventional friction hinge 17 (see FIG. 4). Mounting assembly 14 comprises an elongated guide 18 and a seat connector plate 20 that can be connected to the vehicle seat by suitable connectors. Elongated guide 18 includes oppositely disposed guide rails 22 which, in a manner presently to be described, are adapted to be rollably engaged by two sets of transversely spaced apart roller assemblies 24 (FIG. 2) that are mounted on a transversely extending central head support plate 26 that forms a part of passenger head support assembly 16 (see FIG. 3). The roller assemblies 24, each of which are of identical construction, include grooved rollers 24a that roll along guide rails 22 so that the mounting assembly 14 can be adjustably moved upwardly and downwardly so as to enable the desired adjustment in the height of the support assembly.

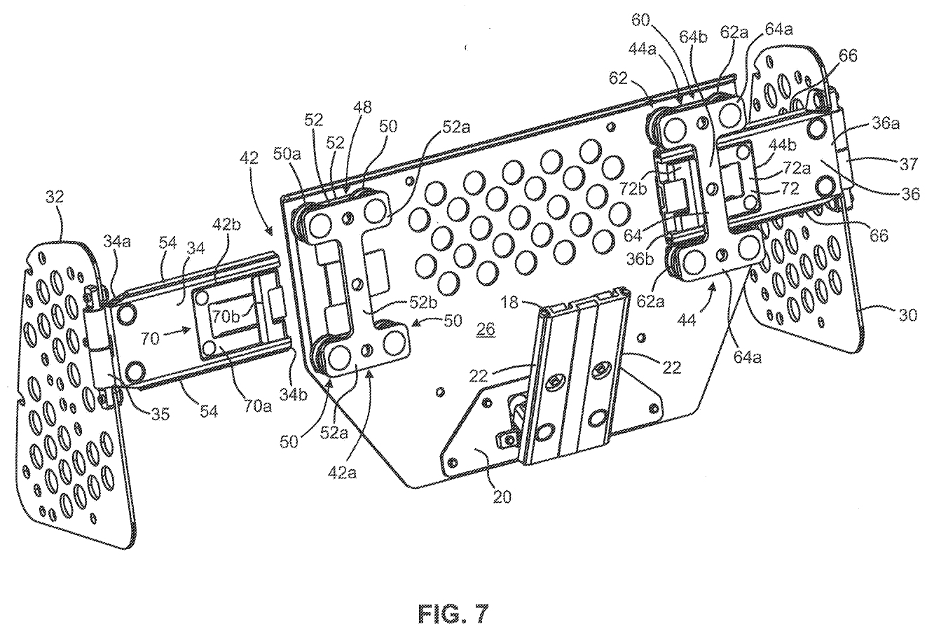

As illustrated in FIG. 1 of the drawings, the transversely extending central head support plate 26 of the passenger head support assembly 16 along with the first and second head support wings 30 and 32 of the assembly, create a passenger head support Wile “Z” within which the passenger's head (H) can comfortably reside. An important feature of the present invention resides in the Ability of the user to adjust the width of the support zone and, if desired, to readily remove the head support wines for remote storage. As best seen in FIG. 2 of the drawings, second head support wing 32: is connected to the outboard end 34a of an elongate first wing connecter 34 by a conventional friction hinge 35. Similarly, first head support wing 30 is connected to the outboard end 36a of an elongate second wing connecter 36 by a conventional friction hinge 37 (FIG. 7).

As illustrated in FIG. 7, the inboard end 34b of elongate first wing connecter 34 is slidably connected to central head support plate 26 by means of a connecter assembly 42 that comprises an assembly 42a and a novel quick release mechanism 42b. Connecter assembly 42 comprises a roller assembly 48 that includes spaced apart roller assemblies 50 that are mounted on an upraised bracket 52 that is, in turn, mounted on central head support plate 26. Bracket 52 comprises a pair of spaced apart legs 52a and a cross member 52b. Connecter assembly 42 also includes oppositely disposed guide rails 54 that are provided on the edges of elongate first wing connecter 34 and are so constructed and arranged to engage the roller assemblies 50. The roller assemblies 50, each of which are of identical construction, include grooved rollers 50a that roll along guide rails 54 so that the first wing connecter 34 can be adjustably moved inwardly and outwardly.

In a similar manner, the inboard end 36b of elongate second wing connecter 36 is slidably connected to central head support plate 26 by means of a connecter assembly 44 that comprises an assembly 44a and a novel quick release mechanism 44b. Connecter assembly 44 comprises a roller assembly 60 that includes spaced apart roller assemblies 62 that are mounted on an upraised bracket 64 that is, in turn, mounted on central head support plate 26. Bracket 64 comprises a pair of spaced apart legs 64a and a cross member 64b. Connecter assembly 44 also includes oppositely disposed guide rails 66 that are provided on the edges of elongate second wing connecter 36 and are so constructed and arranged to engage the roller assemblies 62. The roller assemblies 62, each of which are of identical construction, include grooved rollers 62a that roll along guide rails 66 so that the wing connecter 36 can be adjustably moved inwardly and outwardly.

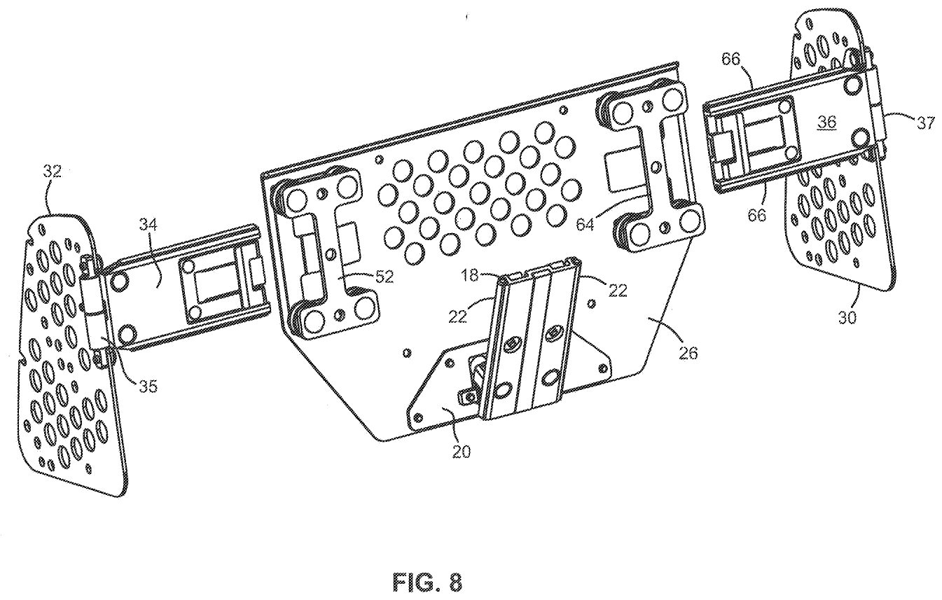

As previously mentioned, both connecter assemblies 42 and 44 include a quick release mechanism that permits the head support wings to be readily disconnected from central head support plate 26 (FIG. 8). Quick: release mechanism 42b of connecter assembly 42 here comprises a generally planar spring 70 that is connected to connector member 34 and at least partially extends beneath upraised bracket 52. Spring 70 here includes a frame portion 70a and an upstanding yieldably deformable, blocking protuberance 70b. Blocking protuberance 70b is so constructed and arranged as to engage the cross member 52b of bracket 52 in a manner to block the outward sliding of connector member 34 and its disconnection from head support plate 26 (see the right hand portion of FIG. 7). Flowerer, a downward pressure exerted on protuberance 70b will allow it to pass under cross member 52b so as to permit outward sliding of member 34 and it's removal from central head support plate 26 in the manner shown in the left hand portion of FIG. 7.

The quick release mechanism 44b of connecter assembly 44 is similar in most respects to quick release mechanism 42b of connector assembly 42 and here comprises a generally planar spring 72 that is connected to connector member 36 and at least partially extends beneath upraised bracket 64. Spring 72 here includes a frame portion 72a and an upstanding yieldably deformable, blocking protuberance 72b. Blocking protuberance 72b is so constructed and arranged as to engage the cross member 64b of bracket 64 in a manner to block the outward sliding of connector member 36 and its disconnection from head support plate 26. However, a downward pressure exerted on protuberance 72b will allow it to pass under cross member 64b so as to permit outward sliding of member 36 and it's removal from central head support plate 26 in the manner shown in the right hand portion of FIG. 8.

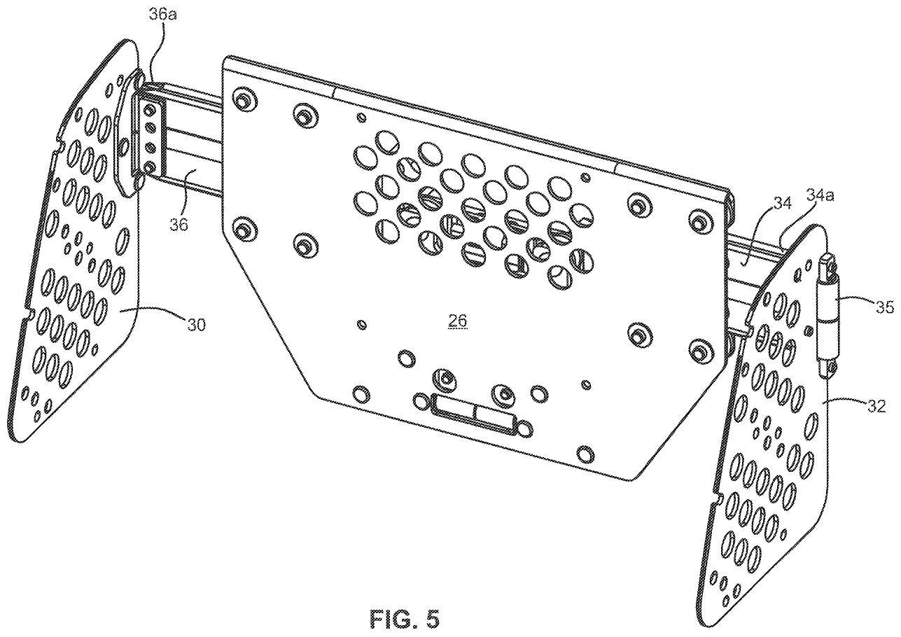

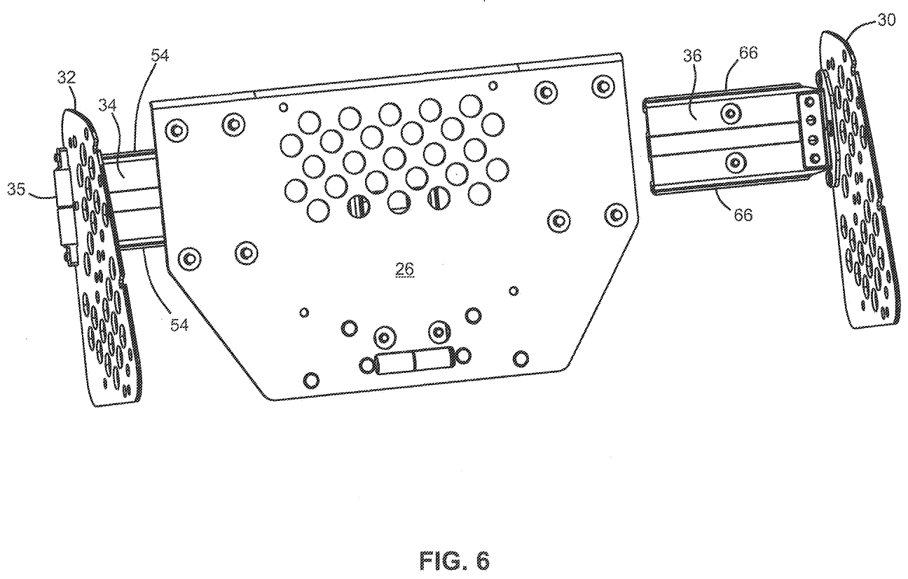

In using the headrest assembly of the invention, the spacing between the wings 30 and 32 can readily be adjusted by sliding either or both of the connectors 34 and 36 inwardly or outwardly of the connector assemblies 42 and 44. For example, the spacing between the wings can be enlarged by sliding the connectors outwardly of the connector assemblies 42 and 44 from the position shown in FIG. 4 to the position shown in FIG. 5. Importantly, by operating the quick release mechanisms 42b and 44b in a manner previously described, one or both of the wings can be removed from the central head support plate 26 for remote storage (see FIGS. 6, 7 and 8).

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention as set forth in the following claims.

I claim:

1. A seat headrest assembly interconnectable with a seat comprising:
(a) a mounting assembly;
(b) a passenger head support assembly support connected to said mounting assembly;
(c) first and second wing connecters slidably connected to said passenger head support assembly for movement between a first position and a second position;
(d) a first head support wing connected to said first wing connecter; and
(e) a second head support wing connected to said second wing connecter.

2. The seat headrest assembly as defined in claim 1 in which said mounting assembly comprises an elongated guide and a seat connector plate connectable to the vehicle seat.

3. The seat headrest assembly as defined in claim 1 further including two sets of transversely spaced apart roller assemblies mounted on said passenger head support assembly.

4. The seat headrest assembly as defined in claim 1 in which said first head support wing is pivotably connected to said first wing connecter and in which said second head support wing is pivotally connected to said second wing connecter.

5. The seat headrest assembly as defined in claim 1 in which said first wing connecter is provided with guide rails.

6. The seat headrest assembly as defined in claim 1 further including a quick release mechanism connected to said connector member for blocking movement of said first wing connecter between a first position and a second position.

7. The seat headrest assembly as defined in claim 6 in which said quick release mechanism comprises a generally planar spring connected to said connector member.

8. The seat headrest assembly as defined in claim 7 in which said generally planar spring includes a frame portion and an upstanding yieldably deformable, blocking protuberance.

9. A seat headrest assembly interconnectable with a seat comprising:
(a) a mounting assembly;
(b) a passenger head support assembly support connected to said mounting assembly;
(c) first and second wing connecters slidably connected to said passenger head support assembly for movement between a first position and a second position;
(d) a first head support wing connected to said first wing connecter;
(e) a second head support wing connected to said second wing connecter; and
(f) a quick release mechanism connected to said first connector member for blocking disconnection said first wing connecter from said passenger bead support assembly.

10. The seat headrest assembly as defined in claim 9 in which said quick release mechanism comprises a generally planar spring comprising a frame portion and an upstanding yieldably deformable blocking protuberance.

11. A seat headrest assembly interconnectable with a seat comprising:
(a) a mounting assembly comprising:
(i) an elongated guide; and
(ii) a seat connector plate connectable to the vehicle seat;
(b) a passenger head support assembly support connected to said mounting assembly;
(c) first and second wing connecters slidably connected to said passenger head support assembly for movement between a first position and a second position;
(d) a first head support wing connected to said first wing connecter;
(e) a second head support wing connected to said second wing connecter; and
(f) a quick release mechanism connected to said first connector member for blocking disconnection said first wing connecter from said passenger head support assembly, said quick release mechanism including a spring comprising:
(i) a frame portion; and
(ii) an upstanding yieldably deformable blocking protuberance.

12. The seat headrest assembly as defined in claim 11 in which said first wing connecter is provided with guide rails.

13. The seat headrest assembly as defined in claim 11 in which said second wing connecter is provided with guide rails.

14. The seat headrest assembly as defined in claim 11 in which said first head support wing is connected to said first wing connecter by a friction hinge and in which said second head support wing is connected to said second wing connecter by a friction hinge.

15. A seat headrest assembly interconnectable with a seat comprising:
(a) a mounting assembly comprising:
(i) an elongated guide having oppositely disposed guide rails; and
(ii) a seat connector plate connectable to the vehicle seat;
(b) a passenger head support connected to said mounting assembly;
(c) first and second sets of transversely spaced apart roller assemblies mounted on said passenger head support;
(d) first and second wing connecters slidably connected to said passenger head support for movement between a first position and a second position;
(e) a first head support wing connected to said first wing connecter by means of a friction hinge;
(f) a second head support wing connected to said second wing connecter means of a friction hinge; and
(g) a quick release mechanism connected to said first connector member for blocking disconnection said first wing connecter from said passenger head support assembly.

16. The seat headrest assembly as defined in claim 15 in which each of said first and second sets of transversely spaced apart roller assemblies include grooved rollers adapted to roll along said guide rails of said elongated guides of said mounting assembly.

17. The seat headrest assembly as defined in claim 15 in which said quick release mechanism includes a spring comprising:
(a) a frame portion; and
(b) an upstanding yieldably deformable blocking protuberance.
